(19) United States
(12) Patent Application Publication
(10) Pub. No.: US 2005/0152481 A1
(43) Pub. Date: Jul. 14, 2005

(54) METHOD AND APPARATUS OF IQ MISMATCH CALIBRATION

(76) Inventors: Ying-Yao Lin, Hsin-Chu Hsien (TW); Chao-Cheng Lee, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/905,496

(22) Filed: Jan. 7, 2005

(30) Foreign Application Priority Data
Jan. 9, 2004 (TW) 093100570
May 10, 2004 (TW) 093113093

(51) Int. Cl. H04L 1/00

(52) U.S. Cl. 375/346

(57) ABSTRACT

A method and an apparatus of IQ mismatch calibration in a radio communication system. The method includes receiving a radio frequency signal, mixing the radio frequency signal with a first carrier to generate an In-phase analog signal, mixing the radio frequency signal with a second carrier to generate a Quadrature-phase analog signal, detecting a phase offset between the In-phase analog signal and the Quadrature-phase analog signal, computing at least a tuning parameter according to the phase offset, and calibrating at least one of the In-phase analog signal and the Quadrature-phase analog signal according to at least one of the phase offset and the tuning parameter such that the In-phase analog signal and the Quadrature-phase analog signal are orthogonal after calibration.

### BACKGROUND OF INVENTION

1. Field of the Invention

The present invention relates to a communication system in a direct down-converting architecture, and more particularly, to a method and an apparatus of IQ mismatch calibration for use in a communication system in a direct down-converting architecture.

2. Description of the Prior Art

Please refer to FIG. 1. FIG. 1 is a diagram of a conventional receiver 10 in a direct down-converting architecture. The receiver 10 comprises an antenna 11, a low noise amplifier (LNA) 12, two mixers 14 and 24, two low pass filters (LPF) 16 and 26, two analog to digital converters (ADC) 18 and 28, and a digital signal processor (DSP) 22. The antenna 11 receives a radio frequency signal, and the LNA 12 amplifies the radio frequency signal. The mixer 14 generates an analog signal Sₐ₁ by mixing the radio frequency signal and a first carrier COS ω_{c}t, and the mixer 24 generates an analog signal Sₐ₂ by mixing the radio frequency signal and a second carrier SIN (ω_{c}t+ψ). The LPFs 16 and 26 filter the high-frequency components of the analog signals Sₐ₁ and Sₐ₂. Additionally, the ADCs 18 and 28 respectively convert the analog signals Sₐ₁ and Sₐ₂ into the corresponding digital signals S_{d1} and S_{d2}. The DSP 22 post-processes the digital signals S_{d1} and S_{d2}.

The phase difference between the first carrier and the second carrier should be 90°, which makes the analog signals Sₐ₁ and Sₐ₂ orthogonal. The analog signals Sₐ₁ and Sₐ₂ are called In-phase signal and Quadrature-phase signal respectively. However, due to the drift of temperature, process variation . . . , etc, the phase difference between the first carrier and the second carrier may not be exactly 90°. Thus, a phase offset ψ between first carrier COS ω_{c}t and second carrier SIN ω_{c}t is generated, which is shown in the form of SIN (ω_{c}t+ψ) in the specification. The phase offset ψ between two carriers may cause the In-phase signal Sₐ₁ and the Quadrature-phase signal Sₐ₂ to be non-orthogonal, which is called IQ mismatch. The phenomena of IQ mismatch may degrade the performance of the following signal demodulation process and the bit error rate (BER) of the communication system may increase. Thus, it is necessary to calibrate IQ mismatch to improve the performance and to increase the bit rate of the communication system.

In the conventional art, there are two approaches to calibrate IQ mismatch. For the analog approach, the phase offset is detected and measured in the digital domain after the In-phase signal and the Quadrature-phase signal are converted by ADC 18 and 28 respectively. Then an analog calibrating signal is generated according to the phase offset to calibrate the I/Q analog signals. For the digital approach, the phase offset is detected and measured to calibrate I/Q digital signals in the digital domain. In the conventional art, the phase offset ψ is detected in the digital domain, and the DSP 22 transforms the digital signals S_{d1} and S_{d2} by a Discrete Fourier Transform (DFT) to compute the phase offset ψ. However, the logic circuitry of the DFT is highly complicated and the power consumption of DFT is also high.

### SUMMARY OF INVENTION

It is therefore one of the objects of the claimed invention to provide a method and an apparatus of IQ mismatch calibration, which detect the phase offset of the In-phase and Quadrature-phase analog signals in the analog domain, to solve the above-mentioned problem.

According to the object mentioned above, a method of IQ mismatch calibration in a radio communication system is disclosed. The method includes receiving a radio frequency signal, mixing the radio frequency signal with a first carrier to generate an In-phase analog signal, mixing the radio frequency signal with a second carrier to generate a Quadrature-phase analog signal, detecting a phase offset between the In-phase analog signal and the Quadrature-phase analog signal, computing at least a tuning parameter according to the phase offset, and calibrating at least one of the In-phase analog signal and the Quadrature-phase analog signal according to at least one of the phase offset and the tuning parameter such that the In-phase analog signal and the Quadrature-phase analog signal are orthogonal after calibration.

According to the object mentioned above, a method of IQ mismatch calibration in a radio communication system is disclosed. The method includes receiving a radio frequency signal, mixing the radio frequency signal with a first carrier to generate an In-phase analog signal, mixing the radio frequency signal with a second carrier to generate a Quadrature-phase analog signal, detecting a phase offset between the In-phase analog signal and the Quadrature-phase analog signal, respectively converting the In-phase analog signal and the Quadrature-phase signal into a corresponding In-phase digital signal and a corresponding Quadrature-phase digital signal, and calibrating at least one of the In-phase analog signal and the Quadrature-phase signal according to the phase offset such that the In-phase digital signal and the Quadrature-phase digital signal are orthogonal.

According to the object mentioned above, an apparatus of IQ mismatch calibration in a radio communication system is disclosed. The apparatus includes an antenna for receiving a radio frequency signal, a first mixer for mixing the radio frequency signal with a first carrier to generate an In-phase analog signal, a second mixer for mixing the radio frequency signal with a second carrier to generate a Quadrature-phase analog signal, a phase detection module for detecting a phase offset between the In-phase analog signal and the Quadrature-phase analog signal, a parameter calculation module for computing at least a tuning parameter according to the phase offset, and a phase calibration module for calibrating at least one of the In-phase analog signal and a Quadrature-phase analog signal through executing IQ mismatch calibration according to the phase offset and the tuning parameter to generate a In-phase analog calibrated signal and a Quadrature-phase analog calibrated signal, wherein the In-phase analog calibrated signal and the Quadrature-phase analog calibrated signal are orthogonal.

According to the object mentioned above, an apparatus of IQ mismatch calibration in a radio communication system is disclosed. The apparatus includes an antenna for receiving a radio frequency signal, a first mixer for mixing the radio frequency signal with a first carrier to generate an In-phase analog signal, a second mixer for mixing the radio frequency signal with a second carrier to generate a Quadrature-phase analog signal, a phase detection module for detecting a phase offset between the In-phase analog signal and the Quadrature-phase analog signal, a first ADC for converting the In-phase analog signal into a corresponding In-phase digital signal, a second ADC for converting the Quadrature-phase analog signal into a corresponding Quadrature-phase digital signal; and a phase calibration module for calibrating at least one of the In-phase digital signal and the Quadrature-phase digital signal according to the phase offset to generate a In-phase digital calibrated signal and a Quadrature-phase digital calibrated signal, wherein the In-phase digital calibrated signal and the Quadrature-phase digital calibrated signal are orthogonal.

The present invention detects the amplitude and the phase offset of the In-phase analog signal and the Quadrature-phase analog signal in the receiver to calibrate the gain of PGA and make I/Q analog signals orthogonal. The prevent invention not only reduces system complexity but also lower power consumption.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a conventional receiver in a direct down-converting architecture.

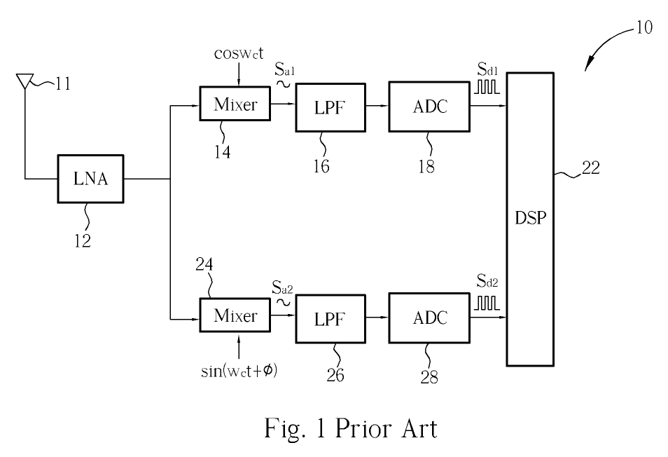

FIG. 2 is a diagram of a receiver in a direct down-converting architecture according to a first embodiment of the present invention.

FIG. 3 is a diagram of the digital calibration module shown in FIG. 2.

FIG. 4 is a diagram of a receiver in a direct down-converting architecture according to a second embodiment of the present invention.

FIG. 5 is a diagram of a receiver in a direct down-converting architecture according to a third embodiment of the present invention.

### DETAILED DESCRIPTION

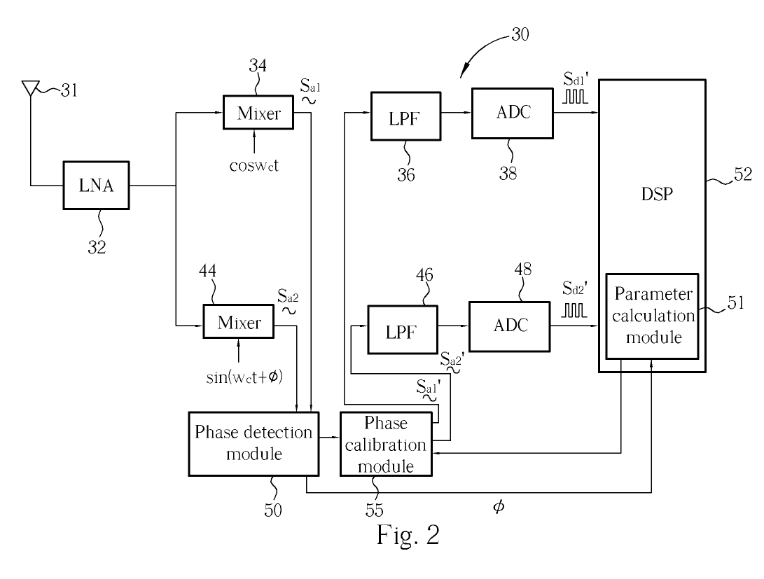

Please refer to FIG. 2. FIG. 2 is a diagram of a receiver 30 in a direct down-converting architecture according to a first embodiment of the present invention. The receiver 30 comprises an antenna 31, a LNA 32, mixers 34 and 44, LPFs 36 and 46, ADCs 38 and 48, a phase detection module 50, a phase calibration module 55, a parameter calculation module 51, and a digital signal processor (DSP) 52. The antenna 31 receives a radio frequency signal, and the LNA 32 amplifies the radio frequency signal. The mixer 34, coupled to the LNA 32, generates an analog signal Sₐ₁ by mixing the radio frequency signal with a first carrier COS ω_{c}t. Additionally, The mixer 44 generates an analog signal Sₐ₂ by mixing the radio frequency signal with a second carrier SIN (ω_{c}t+ψ). The analog signal Sₐ₁ and the analog signal Sₐ₂ respectively are the In-phase analog signal and the Quadrature-phase signal with a phase offset ψ. In the first embodiment of the present invention, the phase detection module 50 is coupled to the mixers 34, 44 respectively for detecting the phase offset ψ between the analog signal Sₐ₁ and the analog signal Sₐ₂. The phase detection module 50 of detecting the phase offset ψ can be implemented in a simple circuit such as a phase frequency detector (PFD), which is widely used in various kinds of phase lock loops (PLLs). The phase frequency detector not only reduces circuit complexity but also lower power consumption. After detecting the phase offset ψ, the phase detection module 50 transmits the detected result to the parameter calculation module 51 to calculate the required parameters. In the embodiment of the preset invention, the parameter calculation module 51 is set in the DSP 52. However, the parameter calculation module 51 can be an individual digital circuit, which is within the scope of the present invention.

In the embodiment, the IQ mismatch calibration procedure is known as Gram-Schmidt orthogonal procedure, illustrated as the following equations. The I/Q analog signals are indicated as:
I=A cos (ω_{c}t) (1)
Q=A sin (ω_{c}t+φ) (2)

The I/Q analog signals, calibrated by the parameters of the equation, are shown as:
I′=A cos (ω_{c}t)×cos φ (3)

$$\begin{matrix}{Q}^{′} = A cos ( {w}_{c} t ) \times ( - sin ϕ ) + A sin ( {w}_{c} t + ϕ ) \\ = - A cos {w}_{c} t sin ϕ + A ( sin {w}_{c} t cos ϕ + cos {w}_{c} t sin ϕ ) \\ = A sin {w}_{c} t \times cos ϕ\end{matrix} \qquad ( 4 )$$

Shown as the equations (3) and (4), the phase difference of the calibrated analog signals I′ and Q′ is a multiple of 90°. The calibration procedure makes the analog signals I′ and Q′ orthogonal to each other.

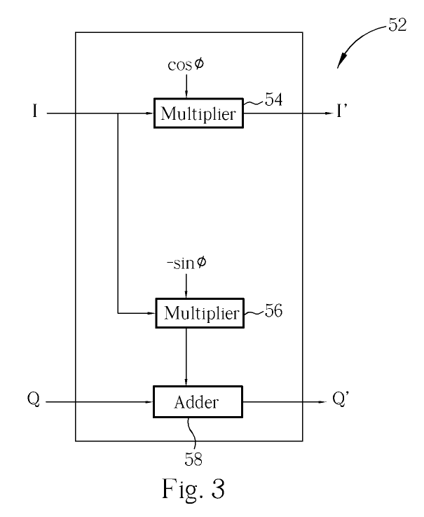

Please refer to FIG. 3. FIG. 3 is a diagram of the phase calibration module 55 shown in FIG. 2. The phase calibration module 55 comprises multipliers 54 and 56, and an adder 58. I and Q are the analog signals with a phase offset ψ, while I′ and Q′ are the analog signals calibrated by the phase calibration module 55. The analog signal I generates a corresponding analog signal I′ by multiplying the cosine of the phase offset ψ in the multiplier 54. The analog signal Q is added to the product of the analog signal I and −sin ψ, outputted from the multiplier 56, to generate a corresponding analog signal Q′ outputted from the adder 58. The adder 58 also performs subtraction such that the product of the analog signal I and sin ψ outputted from the multiplier 56 is subtracted from the digital signal Q, and generates the corresponding digital signal Q′ output from the adder 58. Additionally, the values of cos ψ and sin ψ can be easily calculated by the parameter calculation module 51.

The calibrated I/Q analogs Sₐ₁′ and Sₐ₂′ are orthogonal signals, which are respectively transmitted to the LPFs 36 and 46. The LPF 36 filters the high-frequency signals of the analog signal Sₐ₁′ beyond a first specified bandwidth. The ADC 38 converts the analog signal Sₐ₁′ into a corresponding digital signal S_{d1}′. The LPF 46 filters the high-frequency signals of the analog signal Sₐ₂′ beyond a second specified bandwidth. The first specified bandwidth is substantially equal to the second specified bandwidth in the first embodiment of the present invention. The ADC 48 converts the analog signal Sₐ₂′ into a corresponding digital signal S_{d2}′.

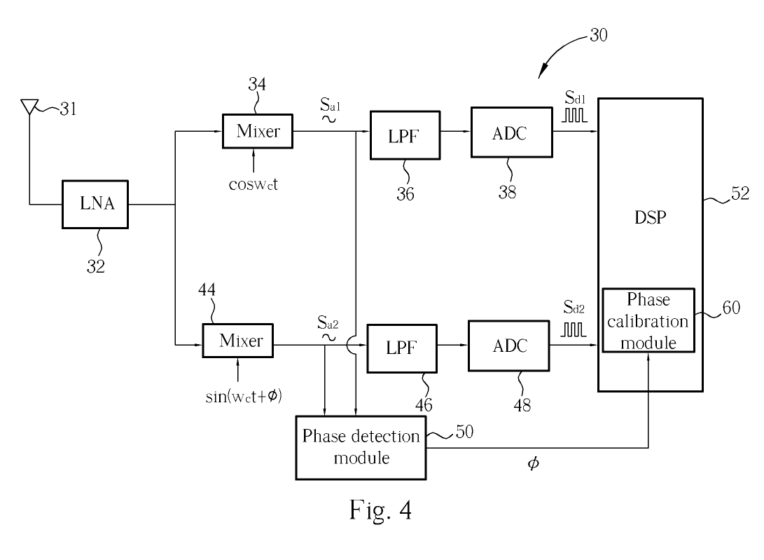

Please refer to FIG. 4. FIG. 4 is a diagram of a receiver 30 in a direct down-converting architecture according to a second embodiment of the present invention. Same as the first embodiment, the phase detection module 50 is used to detect the phase offset of I/Q analog signals. The difference from the first embodiment is that the phase detection module 50 detects the phase offset of the I/Q analog signals in the analog domain and outputs the phase offset to the phase calibration module 60 of the DSP 52. The phase calibration module 60 calibrates the I/Q digital signal S_{d1} and S_{d2}, converted from the I/Q analog signals Sₐ₁ and Sₐ₂ by the ADCs 38 and 48, to be orthogonal according to the phase offset outputted by the phase detection module 50. It should be noted that the phase calibration module 60 is either set within the DSP 52 or an individual digital circuit.

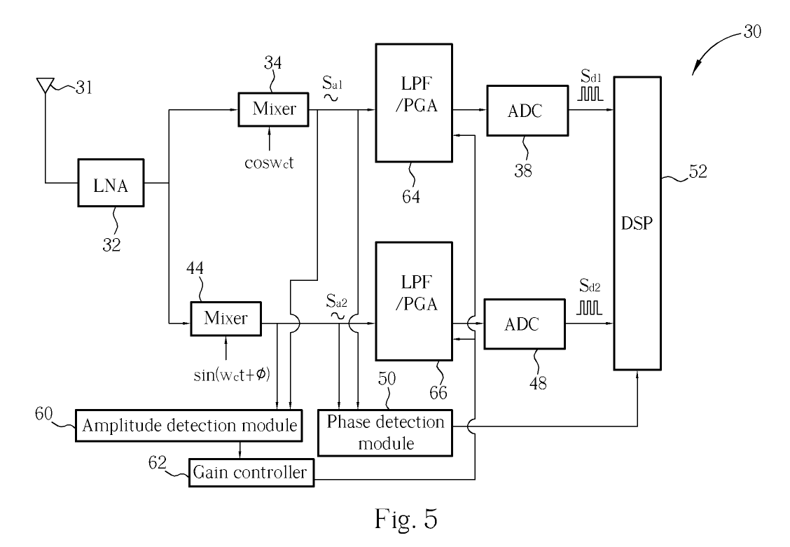

Please refer to FIG. 5. FIG. 5 is a diagram of a receiver 30 in a direct down-converting architecture according to a third embodiment of the present invention. Compared to the second embodiment in FIG. 4, the receiver 30 in FIG. 5 further comprises an amplitude detection module 60, a gain controller 62, and LPF/programmable gain amplifiers (PGA) 64 and 66. The amplitude detection module 60 detects the amplitudes of the I/Q analog signals Sₐ₁ and Sₐ₂, and outputs them to the gain controller 62. The gain controller 62 outputs gain control signals to the LPF/PGA 64 and 66 respectively according to the amplitude difference between the I/Q analog signals Sₐ₁ and Sₐ₂. The LPF/PGAs 64 and 66 filter the high-frequency components of signals, and respectively calibrate the amplitudes of the analog signals Sₐ₁ and Sₐ₂ in a programmable way according to the gain control signals. It should be noted that the LPF/PGAs 64 and 66 are not limited in the positions shown in FIG. 5. They also can be implemented in the analog domain, which is within the scope of the present invention. In addition, the third embodiment can be combined with the first embodiment in FIG. 2 to compensate the phase and amplitude errors between the In-phase and the Quadrature-phase signals to accomplish IQ mismatch calibration, which is within the scope of the present invention as well.

Those skilled in the art will readily observe that numerous modifications and alterations of the device may be made while retaining the teachings of the invention. Accordingly, that above disclosure should be construed as limited only by the metes and bounds of the appended claims.

1. A method of IQ mismatch calibration in a communication system, the method comprising:
receiving a radio frequency signal;
mixing the radio frequency signal with a first carrier to generate an In-phase analog signal;
mixing the radio frequency signal with a second carrier to generate a Quadrature-phase analog signal;
detecting a phase offset between the In-phase analog signal and the Quadrature-phase analog signal;
computing at least a tuning parameter according to the phase offset; and
calibrating at least one of the In-phase analog signal and the Quadrature-phase analog signal according to at least one of the phase offset and the tuning parameter such that the In-phase analog signal and the Quadrature-phase analog signal are orthogonal after calibration.

2. The method of claim 1 wherein the IQ mismatch calibration step is performed by Gram-Schmidt orthogonal procedure.

3. The method of claim 1 wherein a phase offset of the first carrier and the second carrier makes the In-phase analog signal and the Quadrature-phase signal, derived by respectively mixing the radio frequency signal with the first carrier and the second carrier, non-orthogonal.

4. The method of claim 1 further comprising:
filtering the In-phase analog signal beyond a first specified bandwidth; and
filtering the Quadrature-phase analog signal beyond a second specified bandwidth.

5. The method of claim 4 wherein the first specified bandwidth is substantially equal to the second specified bandwidth.

6. The method of claim 1 further comprising:
detecting an amplitude of the In-phase analog signal and the Quadrature-phase analog signal respectively; and
tunig the amplitude such that the amplitude of the In-phase analog signal being substantially equal to the amplitude of the Quadrature-phase analog signal.

7. The method of claim 1 further comprising:
converting the In-phase analog signal and the Quadrature-phase analog signal to a corresponding In-phase digital signal and a corresponding Quadrature-phase digital signal respectively after calibration.

8. A method of IQ mismatch calibration in a communication system, the method comprising:
receiving a radio frequency signal;
mixing the radio frequency signal with a first carrier to generate an In-phase analog signal;
mixing the radio frequency signal with a second carrier to generate a Quadrature-phase analog signal;
detecting a phase offset between the In-phase analog signal and the Quadrature-phase analog signal;
respectively converting the In-phase analog signal and the Quadrature-phase signal into a corresponding In-phase digital signal and a corresponding Quadrature-phase digital signal; and
calibrating at least one of the In-phase analog signal and the Quadrature-phase signal according to the phase offset such that the In-phase digital signal and the Quadrature-phase digital signal are orthogonal.

9. The method of claim 8 wherein a phase offset of the first carrier and the second carrier makes the In-phase analog signal and the Quadrature-phase signal, derived by respectively mixing the radio frequency signal with the first carrier and the second carrier, non-orthogonal.

10. The method of claim 8 further comprising:
filtering the In-phase analog signal beyond a first specified bandwidth; and
filtering the Quadrature-phase analog signal beyond a second specified bandwidth.

11. The method of claim 10 wherein the first specified bandwidth is substantially equal to the second specified bandwidth.

12. The method of claim 8 further comprising:
detecting an amplitude of the In-phase analog signal and the Quadrature-phase analog signal respectively; and
tunig the amplitude such that the amplitude of the In-phase analog signal being substantially equal to the amplitude of the Quadrature-phase analog signal.

13. An apparatus of IQ mismatch calibration in a communication system, the apparatus comprising:
an antenna for receiving a radio frequency signal;
a first mixer for mixing the radio frequency signal with a first carrier to generate an In-phase analog signal;
a second mixer for mixing the radio frequency signal with a second carrier to generate a Quadrature-phase analog signal;
a phase detection module for detecting a phase offset between the In-phase analog signal and the Quadrature-phase analog signal;
a parameter calculation module for computing at least a tuning parameter according to the phase offset; and
a phase calibration module for calibrating at least one of the In-phase analog signal and a Quadrature-phase analog signal through executing IQ mismatch calibration according to the phase offset and the tuning parameter to generate a In-phase analog calibrated signal and a Quadrature-phase analog calibrated signal , wherein the In-phase analog calibrated signal and the Quadrature-phase analog calibrated signal are orthogonal.

14. The apparatus of claim 13 wherein the phase detection module is a phase frequency detector (PFD).

15. The apparatus of claim 13 wherein the phase calibration module performs Gram-Schmidt orthogonal procedure.

16. The apparatus of claim 15 wherein the parameter calculation module performs a digital-signal-processing step to calculate at least a tuning parameter.

17. The apparatus of claim 1 5 wherein the phase calibration module comprises:
a first multiplier for generating the In-phase analog calibrated signal according to the cosine value of the phase offset and the In-phase analog signal;
a second multiplier for generating a first calibrated signal according to the sine value of the phase offset and the In-phase analog signal; and
an adder for generating the Quadrature-phase analog calibrated signal according to the first calibrated signal and the Quadrature-phase analog signal.

18. The apparatus of claim 13 further comprising:
a first analog to digital converter (ADC) for converting the In-phase analog calibrated signal into a corresponding In-phase digital signal; and
a second ADC for converting the Quadrature-phase analog calibrated signal into a corresponding Quadrature-phase digital signal.

19. The apparatus of claim 13 further comprising:
a first filter for filtering the In-phase analog signal beyond a first specified bandwidth; and
a second filter for filtering the Quadrature-phase analog signal beyond a second specified bandwidth.

20. The apparatus of claim 19 wherein the first specified bandwidth is substantially equal to the second specified bandwidth.

21. The apparatus of claim 13 further comprising:
an amplitude detection module for detecting an amplitude of the In-phase analog signal and the Quadrature-phase analog signal respectively; and
a programmable gain amplifier (PGA) for tunig the amplitude of one of the In-phase analog signal and the Quadrature-phase analog signal according to the amplitude.

22. The apparatus of claim 13 wherein the radio communication system is a direct down-conversion communication system.

23. An apparatus of IQ mismatch calibration in a communication system, the apparatus comprising:
an antenna for receiving a radio frequency signal;
a first mixer for mixing the radio frequency signal with a first carrier to generate an In-phase analog signal;
a second mixer for mixing the radio frequency signal with a second carrier to generate a Quadrature-phase analog signal;
a phase detection module for detecting a phase offset between the In-phase analog signal and the Quadrature-phase analog signal;
a first ADC for converting the In-phase analog signal into a corresponding In-phase digital signal;
a second ADC for converting the Quadrature-phase analog signal into a corresponding Quadrature-phase digital signal; and
a phase calibration module for calibrating at least one of the In-phase digital signal and the Quadrature-phase digital signal according to the phase offset to generate a In-phase digital calibrated signal and a Quadrature-phase digital calibrated signal, wherein the In-phase digital calibrated signal and the Quadrature-phase digital calibrated signal are orthogonal.

24. The apparatus of claim 23 wherein the phase detection module is a phase frequency detector (PFD).

25. The apparatus of claim 23 further comprising:
a first filter for filtering the In-phase analog signal beyond a first specified bandwidth; and
a second filter for filtering the Quadrature-phase analog signal beyond a second specified bandwidth.

26. The apparatus of claim 25 wherein the first specified bandwidth is substantially equal to the second specified bandwidth.

27. The apparatus of claim 23 further comprising:
an amplitude detection module for detecting an amplitude of the In-phase analog signal and the Quadrature-phase analog signal respectively; and
a programmable gain amplifier (PGA) for tunig the amplitude of one of the In-phase analog signal and the Quadrature-phase analog signal according to the amplitude.

28. The apparatus of claim 23 wherein the radio communication system is a direct down-conversion communication system.
